(19) United States
(12) Patent Application Publication
(10) Pub. No.: US 2008/0280750 A1
(43) Pub. Date: Nov. 13, 2008

(54) Catalysts for treating acid and halogen gases and production methods thereof

(76) Inventor: Pao-Chu Liu, Taoyuan County (TW)

Correspondence Address: BACON & THOMAS, PLLC, 625 SLATERS LANE, FOURTH FLOOR, ALEXANDRIA, VA, 22314-1176, US

(21) Appl. No.: 12/149,628

(22) Filed: May 6, 2008

(30) Foreign Application Priority Data
May 9, 2007 (TW) 96116521

(51) Int. Cl. B01J 27/053; B01J 27/055; B01J 21/18; B01J 31/06; B01J 23/04; B01J 23/02; B01J 23/10; B01J 23/14; B01J 23/34; B01J 23/72; B01J 23/78; B01J 23/83; B01J 23/835; B01J 23/889; B01J 23/745; B01J 23/75; B01J 23/755; B01J 21/02; B01J 21/06; B01J 21/16

(52) U.S. Cl. 502/63; 502/344; 502/174; 502/340; 502/355; 502/202; 502/349; 502/217; 502/341; 502/242; 502/352; 502/218; 502/337; 502/338; 502/84; 502/243; 502/250; 502/324; 502/263; 502/73; 502/335; 502/336; 502/345; 502/346; 502/330; 502/304; 502/350; 502/351; 502/159; 502/207; 502/241; 502/244; 502/259; 502/260; 502/74

(57) ABSTRACT

Catalysts for treating acid gases and halogen gases and the production methods thereof. The acid and halogen gases include HCl, HF, HBr, HI, F₂, Cl₂, Br₂, I₂, ClF₃, PH₃, PCl₃, PCl₅, POCl₃, P₂O₅, AsH₃, SiH₄, SiF₄, SiCl₄, SiHCl₃, SiH₂Cl₂, BF₃, BCl₃, GeCl₄, GeH₄, NO, NO₂, SO₂, SO₃ and SF₆, etc.

The catalysts comprise one or more carrier materials selected from activated carbon, argil, diatomite, cement, silica and ceramic materials; and one or more metal compounds selected from: alkali metal hydroxides, oxides, carbonates and bicarbonates, alkaline earth metal hydroxides, oxides, carbonates and bicarbonates, Group IIIA metal oxides, Group IVA metal oxides, and transition metal oxides, oxide hydrates, sulfates and carbonates.

### FIELD OF THE INVENTION

The present invention relates to catalysts for treating acid gases and halogen gases and production methods thereof. In particular, the present invention relates to catalysts for decomposing acid gases and halogen gases produced during the manufacturing processes of semiconductors and photoelectric panels, and to methods for producing the catalysts.

### BACKGROUND OF THE INVENTION

In recent years global climate abnormality becomes more and more significant, and so does damage to the environment due to industry wastes. Advanced countries, environmental protection groups and even high-technology industries therefore have paid much attention to the problems of waste pollution, among which gas emissions impart influences on the environment most directly and immediately. Emissions of acid gases and halogen gases especially are imperative.

The ecological effects of acid gases and halogen gases include occurrence of acid rain and destruction of nearby lives, such as plants. Humans exposed to high-concentration acid gases and halogen gases will suffer chemical burn and inspiration system injury which, when in the worst situation, may lead to death.

Therefore, careful treatments of acid gases and halogen gases massively produced during the manufacturing processes of semiconductors and photoelectric panels should be carried out in order to minimize impacts on the environment.

Nowadays the devices for treating waste gases produced from the manufacturing processes of semiconductors and photoelectric panels generally are of four types, i.e., water-scrubbing, combustion, thermoelectric and dry types. The water-scrubbing type devices are less efficient, need to use a huge amount of water, and can hardly conform to the high environmental protection standards due to the secondary pollution by the generated wastewater. The combustion type devices have the problem of further air pollution by the generated huge amount of CO₂ or other acid gases. The thermoelectric type devices are high energy consumptive and less efficient. In comparison with the other types, the dry type devices lead to more satisfactory treatment results since they are efficient, low energy consumptive, easy to maintain and operable during blackout, and also the problem of secondary pollution could be well controlled.

In the treatment in a dry type device, metallic substances having specific catalytic and reactive properties are used to convert acid gases and halogen gases into more stable solid salts or nontoxic gases, such that the end gases from the device meet the environmental requirements.

### BRIEF DESCRIPTION OF THE DRAWINGS

FIG. 1 schematically depicts a device for catalytically-treating waste gases.

FIG. 2 is a flow chart showing the first embodiment of the production method of the present invention.

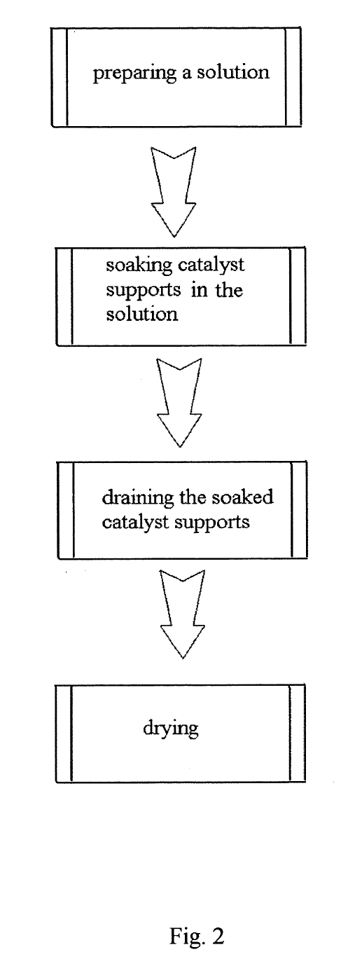

FIG. 3 is a flow chart showing the second embodiment of the production method of the present invention.

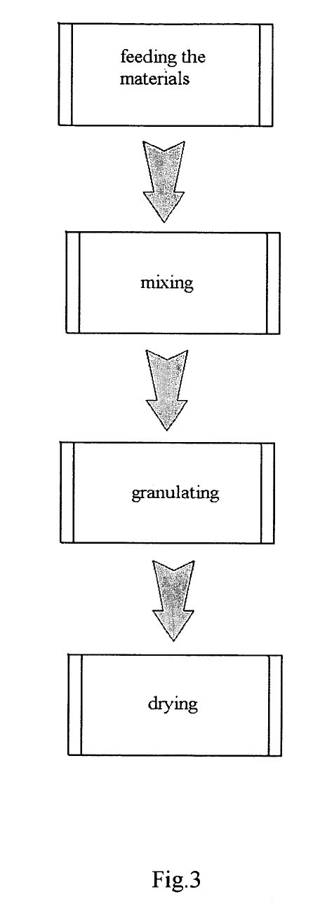

FIG. 4 is a flow chart showing the third embodiment of the production method of the present invention.

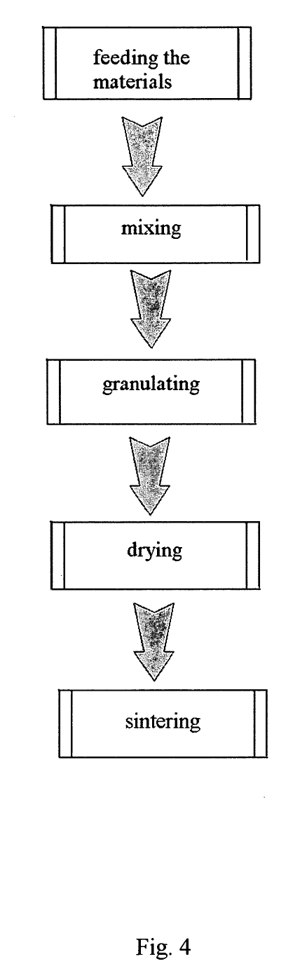

FIG. 5 depicts actual test results obtained by treating various gases with the catalysts of the present invention.

### DETAILED DESCRIPTION OF THE INVENTION

The present invention relates to a catalyst for treating acid gases and halogen gases and the production method thereof. In particular, the present invention relates to a catalyst for decomposing acid gases and halogen gases produced during the manufacturing processes of semiconductors and photoelectric panels, and methods for producing the catalysts.

The catalyst of the present invention is useful for treating acid gases and halogen gases, including HCl, HF, HBr, HI, F₂, Cl₂, Br₂, I₂, ClF₃, PH₃, PCl₃, PCl₅, POCl₃, P₂O₅, AsH₃, SiH₄, SiF₄, SiCl₄, SiHCl₃, SiH₂Cl₂, BF₃, BCl₃, GeCl₄, GeH₄, NO, NO₂, SO₂, SO₃, SF₆, etc.

The catalyst of the present invention comprises one or more support materials, such as those selected from activated carbon, argil, diatomite, cement, silica and ceramic materials (including clay, kaolin, alumina, etc.); optionally one or more binders, such as those selected from polyvinyl alcohol (PVA), water glass and silica sol; and one or more metal compounds selected from alkali metal hydroxides, oxides, carbonates and bicarbonates, alkaline earth metal hydroxides, oxides, carbonates and bicarbonates, Group IIIA metal oxides, Group IVA metal oxides, and transition metal oxides, oxide hydrates, sulfates and carbonates.

The catalyst of the present invention may comprise about 10-90% by weight of the support materials, about 10-90% by weight of the metal compounds and about 560% by weight of the binders.

The abovesaid alkali metal or alkaline metal hydroxides, oxides, carbonates and bicarbonates include Ca(OH)₂, CaCO₃, CaO, K₂CO₃, KHCO₃, KOH, Na₂CO₃, KHCO₃, KOH, Na₂CO₃, NaHCO₃, NaOH, Li₂CO₃, LiHCO₃, LiOH, MgCO₃, MgO, etc. The abovesaid Group IA or IVA metal oxides include Al₂O₃, SiO₂, PbO, SnO₂, SnO, etc. The abovesaid transition metal oxides, oxide hydrates, sulfates and carbonates include Fe₂O₃, Fe₃O₄, Fe₂O₃.H₂O, Fe₂(SO₄)₃, CuO, Cu₂O, CuSO₄, CuCO₃, MnO₂, MnO, MnCO₃, CeO₂, ZrO₂, Y₂O₃, TiO₂, NiO, Ni₂O₃, CoO, CO₂O₃, etc.

In practical applications, various components can be combined to treat various gases, and a device can be loaded with one or more catalysts in various ratios in accordance with the processes to be carried out.

The production method of the catalyst of the present invention for treating acid gases and halogen gases may comprise the steps of soaking the catalyst support(s) in a solution of the active catalytic ingredient(s) in, for example, water or alcohols, and then drying the resulting product; or may comprise the steps of subjecting the catalyst support(s), the active catalytic ingredient(s) and additives (for example, binders) to mixing, granulating and drying, and then sintering at a high temperature if needed. The purpose of sintering the granular mixture formed by granulation is to give the mixture a porous ceramic-like structure. Due to the porous feature of the catalyst product, the contact area between the catalyst and the acid and halogen gases is increased, thereby the reaction rate is increased and the acid and halogen gases can be decomposed rapidly. The abovesaid active catalytic ingredient is one or more metal compounds selected from alkali metal hydroxides, oxides, carbonates and bicarbonates, alkaline earth metal hydroxides, oxides, carbonates and bicarbonates, Group IIIA metal oxides, Group IVA metal oxides, and transition metal oxides, oxide hydrates, sulfates and carbonates.

The catalyst of the present invention can be granulated into various shapes in order to fit various requirements. The shapes include irregular pieces, chips, powders, granules, cylinders, tablets, grids, hives, crystals, etc. The size, structural strength, specific surface area and heat resistance of the catalyst also can be adjusted to fit various requirements in practice.

Preferred embodiments of the catalyst of the present invention include the following three groups:

### 1. Group DT-H-001:

Activated carbon granules are soaked in a 20˜70% solution of K₂CO₃, KHCO₃, KOH, Na₂CO₃, NaHCO₃, NaOH, Li₂CO₃, LiHCO₃ and/or LiOH in water or alcohol(s) for several hours, drained, and dried at a temperature 60˜250° C. for 2˜48 hours to obtain the product. High performance catalysts for treating various gases can thus be produced, and the species of the basic solutions for soaking activated carbon granules depend on the species of the gases to be treated. The catalysts are especially useful for treating halogen gases and hydrogen halide gases, and also are useful for treating perfluorocarbons (PFCs) gases.

### 2. Group DT-H-002:

The following materials (1), (2) and (3) in weight ratio of about 10˜90%:10˜90%: 5˜60% are thoroughly mixed, granulated and dried to obtain the product:

(1) one or more active catalytic ingredients selected from Ca(OH)₂, CaCO₃, CaO, SiO₂, Fe₂O₃.H₂O, Fe₂O₃, Fe₃O₄, Fe₂(SO₄)₃, CuO, Cu₂O, CuSO₄, CuCO₃, MnO₂, MnO, MnCO₃, Al₂O₃, K₂CO₃, KHCO₃, KOH, Na₂CO₃, NaHCO₃, NaOH, Li₂CO₃, LiHCO₃, LiOH, MgCO₃, MgO, NiO, Ni₂O₃, CoO, CO₂O₃, PbO, SnO₂ and SnO;
(2) one or more support materials selected from activated carbon, argil, diatomite, cement, silica and ceramic materials;
(3) one or more binders selected from polyvinyl alcohol (PVA), water glass and silica sol.

The catalysts thus obtained are especially useful for treating hydrogen halide gases, and also are useful for treating PFCs gases.

### 3. Group DT-H-003:

The following materials (1), (2) and (3) in weight ratio of about 20˜80%:20˜80%:5˜60% are thoroughly mixed, granulated, and sintered at a high temperature of 600˜1500° C. for 8˜80 hours to obtained the product:

(1) one or more active catalytic ingredients selected from Ca(OH)₂, CaCO₃, CaO, SiO₂, Fe₂O₃.H₂O, Fe₂O₃, Fe₃O₄, Fe₂(SO₄)₃, CuO, Cu₂O, CuSO₄, CuCO₃, MnO₂, MnO, MnCO₃, Al₂O₃, MgCO₃, MgO, CeO₂, ZrO₂, Y₂O₃, TiO₂, NiO, Ni₂O₃, CoO, CO₂O₃, PbO, SnO₂ and SnO;
(2) one or more support materials selected from activated carbon, argil, diatomite, cement, silica and ceramic materials;
(3) one or more binders selected from polyvinyl alcohol (PVA), water glass and silica sol.

The catalysts thus obtained are particularly useful for treating gases such as F₂, Cl₂, Br₂, I₂, ClF₃, PH₃, PCl₃, PCl₅, POCl₃, P₂O₅, AsH₃, SiH₄, SiF₄, SiCl₄, SiHCl₃, SiH₂Cl₂, BF₃, BCl₃, GeCl₄, GeH₄, NO, NO₂, SO₂, SO₃, SF₆, etc., and also are useful for treating PFCs gases.

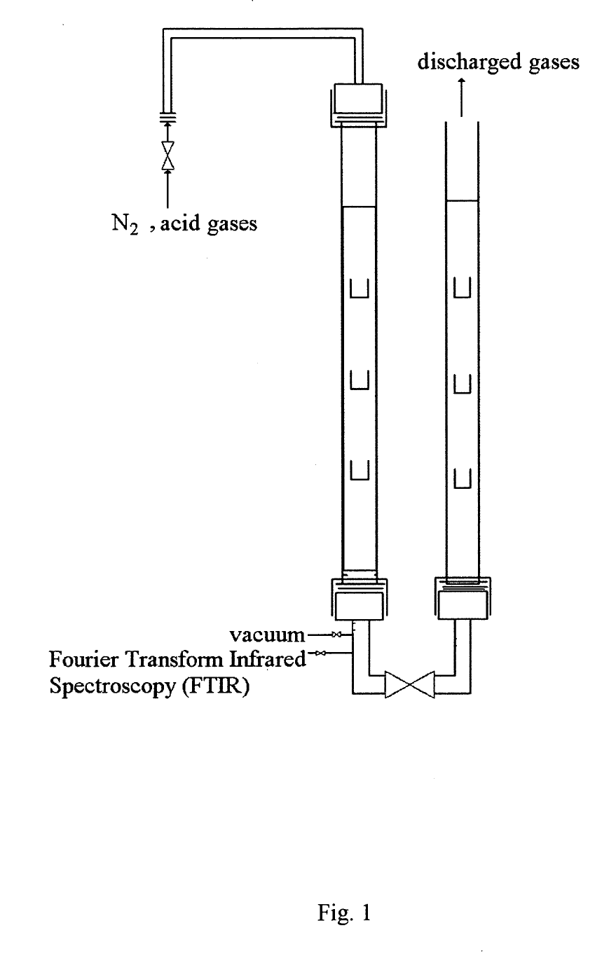

As tested by Fourier Transform Infrared Spectroscopy (FTIR) (the sample may be, for example, collected at the sampling port as shown in FIG. 1), the streams after being treated with the catalysts of the present invention contain less than 10 ppm of acid gases and halogen gases, which contents are low enough to meet the present and future environmental standards.

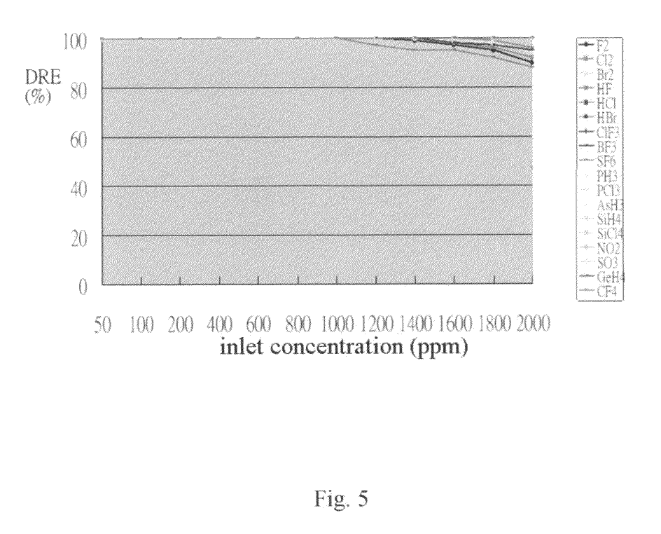

Actual test results obtained by treating various gases with the catalysts of the present invention are shown in FIG. 5 and summarized in the following table, wherein DRE means destruction removal efficiency for various acid gases and halogen gases:

| gas | Inlet (ppm) | flow rate (SLM) | outlet (ppm) | DRE (%) |
|---|---|---|---|---|
| F₂ | 1000 | 100 | <10 | >99 |
| Cl₂ | 1000 | 100 | <10 | >99 |
| Br₂ | 1000 | 100 | <10 | >99 |
| HF | 5000 | 200 | <10 | >99 |
| HCl | 5000 | 200 | <10 | >99 |
| HBr | 5000 | 200 | <10 | >99 |
| ClF₃ | 1000 | 100 | <10 | >99 |
| BF₃ | 1000 | 100 | <10 | >99 |
| SF₆ | 1000 | 100 | <10 | >99 |
| PH₃ | 1000 | 100 | <10 | >99 |
| PCl₃ | 1000 | 100 | <10 | >99 |
| AsH₃ | 1000 | 100 | <10 | >99 |
| SiH₄ | 1000 | 100 | <10 | >99 |
| SiCl₄ | 1000 | 100 | <10 | >99 |
| NO₂ | 5000 | 200 | <10 | >99 |
| SO₃ | 5000 | 200 | <10 | >99 |
| GeH₄ | 1000 | 100 | <10 | >99 |
| CF₄ | 1000 | 50 | <10 | >99 |

The catalysts of the present invention and their production methods will now be described by reference to the following examples which are for illustrative purposes and are not to be construed as a limitation of the scope the present invention.

### EXAMPLE 1

### Production Method of the Group DT-H-001 Catalyst by Soaking Activated Carbon in KOH/K₂CO₃ Solution

A catalyst belonging to the abovesaid Group DT-H-001 can be produced by performing the following steps:

1. 10˜30 g of KOH and 10˜30 g of K₂CO₃ are added into 100 ml of water and completely stirred to dissolve;
2. 20˜70 g of activated carbon is added into the resulting solution to soak the activated carbon at a temperature of from room temperature to 90° C. for 2˜36 hours; and
3. the activated carbon is taken out of the solution, drained, and then dried in a drying oven at a temperature of 60˜250° C. for 2˜48 hours to obtain the final product.

### EXAMPLE 2

### Production Method of the Group DT-H-002 Catalyst by Mixing Ca(OH)₂, CaCO₃, MgO, Ni₂O₃, Fe₂O₃.H₂O and Fe₂O₃

A catalyst belonging to the abovesaid Group DT-H-002 can be produced by performing the following steps:

1. 20˜80 g of Ca(OH)₂, 5˜50 g of CaCO₃, 5˜50 g of MgO, 2˜10 g of Ni₂O₃, 2˜10 g of Fe₂O₃.H₂O, 20˜50 g of Fe₂O₃ and 30 g of SiO₂ are mixed and stirred to be homogeneous;
2. 20˜50 ml of a 2˜40% PVA and 5˜20 ml of water are added into the resulting mixture and thoroughly stirred;
3. the resulting mixture is granulated into the desired shape and size; and
4. the granulated mixture is dried in a drying oven at a temperature of 60˜300° C. for 6˜48 hours to obtain the final product.

### EXAMPLE 3

### Production Method of the Group DT-H-003 Catalyst by Mixing Fe₂O₃, CuO, Cu₂O, CuSO₄, CuCO₃, MnO, MnCO₃, Al₂O₃, CeO₂, ZrO₂, Y₂O₃, TiO₂, Ni₂O₃ and SnO₂

A catalyst belonging to the abovesaid Group DT-H-003 can be produced by performing the following steps:

1. 1˜5 g of Fe₂O₃, 10˜80 g of CuO, 1˜5 g of Cu₂O, 5˜50 g of CuSO₄, 5˜50 g of CuCO₃, 1˜5 g of MnO, 1˜5 g of MnCO₃, 5˜50 g of Al₂O₃, 1˜5 g of CeO₂, 1˜5 g of ZrO₂, 1˜5 g of Y₂O₃, 1˜5 g of TiO₂, 1˜5 g of Ni₂O₃, 1˜5 g of SnO₂, 10˜50 g of pottery clay, 5˜40 g of clay and 5˜30 g of activated carbon powders are mixed and stirred to be homogeneous;
2. 10˜70 ml of a 2˜40% PVA and 5˜40 ml of water are added into the resulting mixture and thoroughly stirred;
3. the resulting mixture is granulated into the desired shape and size;
4. the granulated mixture is dried in a drying oven at a temperature of 60˜300° C. for 6˜48 hours; and
5. the dried product is sintered in a high temperature furnace at a temperature of 600˜1500° C. for 8˜80 hours to obtain the final product.

What is claimed is:

1. A catalyst for treating acid gases and halogen gases, comprising one or more support materials and one or more metal compounds selected from alkali metal hydroxides, oxides, carbonates and bicarbonates, alkaline earth metal hydroxides, oxides, carbonates and bicarbonates, Group IIIA metal oxides, Group IVA metal oxides, and transition metal oxides, oxide hydrates, sulfates and carbonates.

2. The catalyst of claim 1, which can be used for treating acid gases and halogen gases which are selected from HCl, HF, HBr, HI, F₂, Cl₂, Br₂, 12, ClF₃, PH₃, PCl₃, PCl₅, POCl₃, P₂O₅, AsH₃, SiH₄, SiF₄, SiCl₄, SiHCl₃, SiH₂Cl₂, BF₃, BCl₃, GeCl₄, GeH₄, NO, NO₂, SO₂, SO₃ and SF₆.

3. The catalyst of claim 1, wherein the one or more support materials are selected from activated carbon, argil, diatomite, cement, silica and ceramic materials.

4. The catalyst of claim 1, wherein the alkali metal hydroxides, oxides, carbonates and bicarbonates are selected from K₂CO₃, KHCO₃, KOH, Na₂CO₃, NaHCO₃, NaOH, Li₂CO₃, LiHCO₃ and LiOH.

5. The catalyst of claim 1, wherein the alkaline metal hydroxides, oxides, carbonates and bicarbonates are selected from Ca(OH)₂, CaCO₃, CaO, MgCO₃ and MgO.

6. The catalyst of claim 1, wherein the Group IIIA metal oxide is Al₂O₃.

7. The catalyst of claim 1, wherein the Group IVA metal oxides are selected from SiO₂, PbO, SnO₂ and SnO.

8. The catalyst of claim 1, wherein the transition metal oxides, oxide hydrates, sulfates and carbonates are selected from Fe₂O₃, Fe₃O₄, Fe₂O₃.H₂O, Fe₂(SO₄)₃, CuO, Cu₂O, CuSO₄, CuCO₃, MnO₂, MnO, MnCO₃, CeO₂, ZrO₂, Y₂O₃, TiO₂, NiO, Ni₂O₃, CoO and CO₂O₃.

9. The catalyst of claim 1, which comprises about 10˜90% by weight of the support materials and about 10˜90% by weight of the metal compounds.

10. The catalyst of claim 1, which further comprises one or more binders.

11. The catalyst of claim 10, which comprises about 10˜90% by weight of the support materials, about 10˜90% by weight of the metal compounds and about 5˜60% by weight of the binders.

12. The catalyst of claim 9, wherein the binders are selected from polyvinyl alcohol (PVA), water glass and silica sol.

13. A method for the production of the catalyst of claim 1, comprising the steps of subjecting one or more catalyst support materials and one or more metal compounds to mixing, granulating and drying, wherein the metal compounds are selected from alkali metal hydroxides, oxides, carbonates and bicarbonates, alkaline earth metal hydroxides, oxides, carbonates and bicarbonates, Group IIIA metal oxides, Group IVA metal oxides, and transition metal oxides, oxide hydrates, sulfates and carbonates.

14. A method for the production of the catalyst of claim 10, comprising the steps of subjecting one or more catalyst support materials, one or more binders and one or more metal compounds to mixing, granulating and drying, wherein the metal compounds are selected from alkali metal hydroxides, oxides, carbonates and bicarbonates, alkaline earth metal hydroxides, oxides, carbonates and bicarbonates, Group IIIA metal oxides, Group IVA metal oxides, and transition metal oxides, oxide hydrates, sulfates and carbonates.

15. The method of claim 13 or 14, further comprising a sintering step at a high temperature after the drying step.

16. A method for the production of the catalyst of claim 1, comprising the steps of soaking one or more catalyst supports in a solution of one or more metal compounds and then drying the resulting product, wherein the metal compounds are selected from alkali metal hydroxides, oxides, carbonates and bicarbonates, alkaline earth metal hydroxides, oxides, carbonates and bicarbonates, Group IIIA metal oxides, Group IVA metal oxides, and transition metal oxides, oxide hydrates, sulfates and carbonates.

17. The method of claim 16, wherein the solution is a water or alcohol solution.
